(19) United States
(12) Patent Application Publication
(10) Pub. No.: US 2015/0066250 A1
(43) Pub. Date: Mar. 5, 2015

(54) FLIGHT MANAGEMENT SYSTEM TEMPLATES

(71) Applicant: FLYING SOFTWARE LABS, LLC, Draper, UT (US)

(72) Inventors: Jack M. Garzella, Draper, UT (US); Richard Coke Marshall, III, Draper, UT (US)

(21) Appl. No.: 14/019,302

(22) Filed: Sep. 5, 2013

(51) Int. Cl. G08G 5/00; B64D 43/00; G05D 1/10

(52) U.S. Cl. CPC G08G 5/0021; G05D 1/10; B64D 43/00
USPC 701/3

(57) ABSTRACT

A method is described for determining access to functionality of a flight management system. The method may include constructing at least one user profile and determining access to functionality of the flight management system using a role and a user profile. One or more roles and one or more user profiles may be identified for a user. Upon receiving a request from the user to perform an action, a determination may be made whether to perform the action by validating the role and user profile data contained in the user profile. After validating the role and the profile data, the action requested by the user may be performed.

### BACKGROUND

Those wishing to become aircraft pilots in most cases attend a flight training school where a course of study is used to teach a student to pilot an aircraft. Through flight training, a student may be taught primary and intermediate airmanship skills that provide the student with an acquaintance of the principles of flight. As a result, a student may leave flight school having an ability to operate an aircraft with competence and precision on the ground and in the air, as well as the ability to exercise good judgment in the operation, safety and efficiency of an aircraft.

In addition to managing the ordinary operations of a flight business, some flight training schools may be subject to government scrutiny. For instance, aircrafts, flight instructors and pilot training activities may be regulated by governments. Due to flight training related regulations, flight training schools may be burdened with additional procedures, rules and paperwork that add complexity to managing a flight training school. For example, pilot certification may require: minimum flight instruction time, individual solo flight time, minimum age requirement, medical certification and successful completion of a number of written, oral and flight tests. In addition, flight instructors may be regulated and may need to be certified in order to instruct a student. In a case where a requirement may have been missed or neglected, a flight training school may face serious consequences.

### BRIEF DESCRIPTION OF THE DRAWINGS

FIG. 1 is a diagram illustrating an example system for determining flight management system access for a user based on a user role and a user profile.

FIG. 2 is a block diagram illustrating an example system for constructing a user profile and determining access to a flight management system based in part on the user profile.

FIG. 3 is a flow diagram that illustrates an example method for constructing a multi-role user profile for a flight management system.

FIG. 4 is a flow diagram illustrating an example method for determining access to functionality of a flight management system.

FIG. 5 is a diagram illustrating an example graphical user interface displaying available profile templates that can be selected by a user.

FIG. 6 is a diagram that illustrates an example graphical user interface displaying a user profile.

FIG. 7 is a diagram illustrating an example graphical user interface that can be used to book a flight lesson.

FIG. 8 is a block diagram illustrating an example of a computing device used for constructing a user profile and determining access to a flight management system based in part on the user profile.

### DETAILED DESCRIPTION

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical terms used herein have the same meaning as commonly understood by one of ordinary skill in the art to which this disclosure belongs.

A technology is described for constructing a user profile using profile templates and determining user access to functionality of a flight management system using a role and one or more profiles. The present technology allows for multiple user profiles to be associated with a single user role (one-to-many) and multiple user profiles to be associated with multiple user roles (many-to-many). A flight management system may help entities that operate flight businesses and/or clubs. For instance, a flight entity may include flight schools that teach students to operate various aircraft, flight businesses that rent and/or charter aircraft to the public and flight clubs comprised of member pilots. A flight management system may be used to track a pilot's progress, validate that flight training rules are being followed, track aircraft used by a flight entity, schedule flight resources and courses, ensure compliance to governmental regulations and proprietary rules, integrate billing features as well as other functions related to a flight entity. For example, a flight management system may help flight schools to adhere to FAA (Federal Aviation Administration) rules and regulations by monitoring student and instructor compliance to the rules and regulations.

Currently, flight entities that use existing systems may be limited to a single user role and profile when setting up a user within a system. For example, when setting up a user, a system administrator may select a user role (e.g., student, pilot, instructor, mechanic, staff, dispatch, back office administrator, super administrator, maintenance manager, curriculum manager, audit, report, visitor, tourist, etc.) and then the administrator may create a profile from a static profile template for the user where the static profile template may contain fields that may be related to an associated user role. In the case where a user holds additional roles within a flight entity, the user may need additional accounts set up for the user within an existing system. In other words, when a user is acting within a pilot role, the user may have to login to a system using a pilot account. Later, acting within an aircraft maintenance role, the user may have to logout of the system and then log back in using an aircraft maintenance account.

The current technology allows an administrator of a flight management system to assign multiple roles to a single user where each role may have one or more associated user profiles. Thus, a user who may be a pilot and an aircraft mechanic within a flight entity may be assigned a pilot role and an aircraft maintenance role and may have an associated pilot profile and aircraft maintenance profile. When the user logs into the flight management system, the pilot role and the aircraft maintenance role assigned to the user may be identified along with the pilot profile and the aircraft maintenance profile. Once the user is logged in, the user may perform any action that may be associated with the one or more user roles and user profiles that have been assigned to the user.

In an example configuration, a user's access to a flight management system and associated functionality may be determined by one or more user roles and one or more user profiles that may be associated with a user. A user role may define a user's place within a flight management system's hierarchy and may define certain system rights granted to the user. For example, a user role may be an administrator (admin), instructor, pilot, maintenance, staff, etc. An administrator user role may be granted unlimited rights within the flight management system where the user can view any available information within the flight management system. Whereas a pilot user role may allow a user to only view information and system functionality that may be related to the pilot user role.

A user profile may be a collection of attributes associated with a user that can be used to determine, based on the attributes, whether the user can perform certain actions within the flight management system. For example, attributes from a user's pilot profile may be used to determine whether the user may be qualified to operate a particular aircraft that may be available to rent. Attributes that may have a bearing on whether the user can operate a particular aircraft or not may be attributes such as, medical clearance or aircraft certifications for the particular aircraft.

In one example configuration, a method may be used to identify one or more user roles and one or more user profiles associated with a user when the user makes a request to perform some action within the flight school management system. A user role can be used to determine whether the user may be authorized to perform the action and attributes of a user profile can be used to determine whether the user has the proper credentials to perform the action. In the case where the user may have a user role and a user profile that allow the user to perform the action, the flight school management system may then execute the action requested by the user.

In another example configuration, a profile template can be used to build a user profile for a user of a flight management system. Identifying a user role for the user, a profile template type may be selected and initialized for the user. Examples of profile template types may include, a user enrollment template, a flight instructor template, an aircraft renter template, a flight student template, a flight course template, a staff template, a maintenance template, an external template, a rules template, a security template, an aircraft template, as well as other profile template types that may be used within a flight management system. As an example, a user with a pilot user role may be presented with an enrollment profile template and an aircraft renter profile template. Each profile template type can have multiple profile templates that may be associated with the profile template type. For example, a renter profile template may have a general public pilot enrollment template, and a student pilot template associated with the enrollment profile template. Once a profile template may be selected, at least one field of the profile template may be populated with pre-determined data based upon the profile template. For example, a user may select a certain aircraft from a drop down field in the profile template and information for that aircraft may be automatically populated in template fields that are associated with the drop down field. Custom template fields may be provided to a user that may be incorporated into the profile template and information entered into the custom template fields may be identified so that the information may be included in a user profile. Information entered into a profile template can be validated using criteria that may seek to ensure that the information complies with flight management system standards.

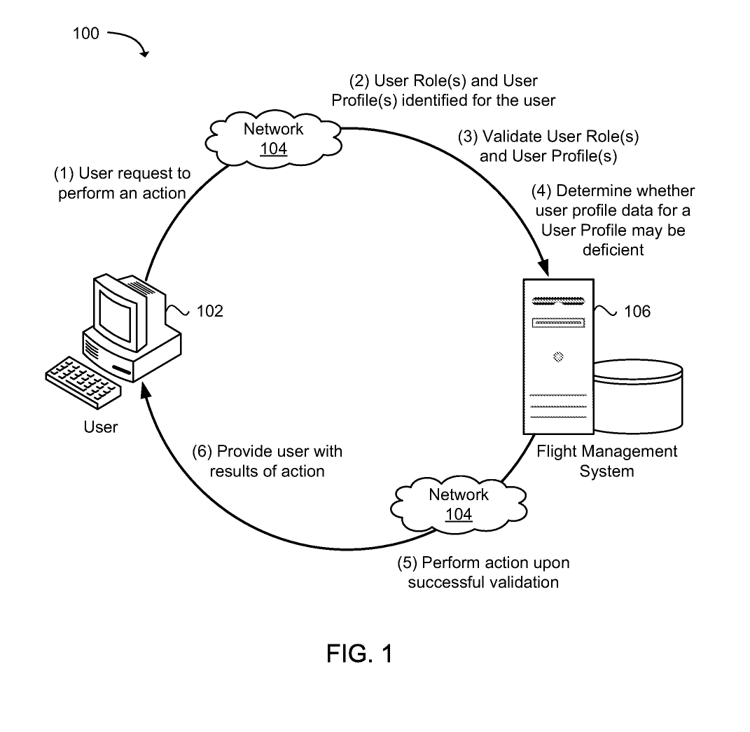

FIG. 1 is a diagram illustrating an example system 100 for determining flight management system access for a user based on a user role and a user profile. The system 100 may include a client device 102 that may be in communication with a flight management system 106 by way of a network 104. A user can access the flight management system 106 using the client device 102. Upon accessing the flight management system 106, one or more user roles and one or more user profiles may be identified for the user. A user may have more than one user role. For example a user may be a pilot, a student, an instructor, a maintenance worker, a staff member and/or some other type of flight entity user. When a user accesses the flight management system 106, any user role that may be assigned to the user can be identified and functionality of the flight management system 106 that may be associated with one or more user roles can be made available to the user. For example, where a user has multiple user roles, functionality for the multiple user roles may be made available to the user in the flight management system 106. As a more specific example, if the user has a pilot user role and an instructor user role, then the user may have access to functionality that allows the user to rent an aircraft as a general public customer and the user may have access to a lesson calendar that allows the user to view flight lessons that the user may be scheduled to teach.

One or more user profiles may be identified for a user when the user accesses the flight management system 106. A user profile may be a collection of attributes that describe a user in relation to a user role assigned to the user. For example, a user profile may contain personal information for a user, such as the user's name, address, contact information, payment information, etc. A user profile may also contain information that may be specific to a user role assigned to a user. For example, a user that may be assigned a pilot user role may have a pilot profile that contains information about aircraft that the user may be certified to operate. For instance, a pilot profile may indicate that a user is certified to fly a single engine airplane using round dial instruments. In one example configuration, a user profile may contain information that relates to a number of user roles assigned to a user. As a specific example, a user profile may contain information associated with a pilot user role and an instructor user role. In another example configuration, a separate user profile may be created for each user role assigned to a user. Specifically, a user having a pilot user role and an instructor user role may have one user profile containing information related to the pilot user role and another user profile containing information related to the instructor user role.

When a user makes a request to perform an action within the flight management system 106, the system may first validate that the user is assigned the correct user role to perform the action and that information contained in a user profile belonging to the user corresponds with certain criteria that may be associated with the action. As an example, an action to rent an aircraft may necessitate that a user be assigned a user role that allows the user to rent an aircraft. Furthermore, the user profile for the user may need to contain information that indicates that the user is medically cleared to fly an aircraft.

In a case where a user profile may be missing information that may be necessary before an action can be performed within the flight management system 106, a user may be informed that the user profile belonging to the user may be deficient. Also, if information in a user profile belonging to the user may not correspond with criteria associated with performing an action, a user may be notified that the user may not be certified to perform the action. For example, a user may request to rent a particular airplane, but the user may lack proper certification to operate the airplane. The fact that the user lacks the proper certification may be reflected in the user's profile and the user may be notified that the rental action cannot be performed due to the lack of certification.

Upon successful validation of one or more user roles and one or more user profiles for a user, an action requested by the user may be performed within the flight management system 106 and the results of the action may be provided to the user via the client device 102. For example, a user wishing to rent an aircraft may be provided with a notification that the aircraft has been reserved for the user.

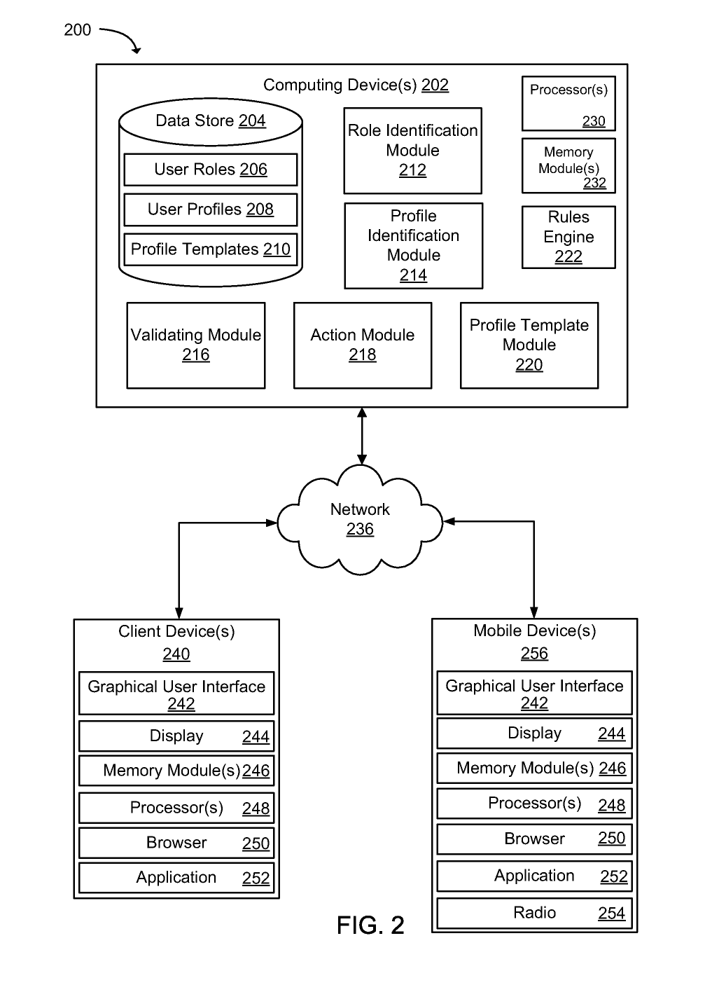

FIG. 2 illustrates an example of various components of a flight management system 200 on which the present technology may be executed. The example flight management system 200 may be used to construct a user profile using a profile template and to determine flight management system 200 access for a user based on a user role and the user profile. The flight management system 200 may contain one or more computing devices 202 that may be in communication with a number of client devices 240 and/or mobile devices 256 by way of a network 236.

In one example configuration, the computing device 202 may include a data store 204 that contains various data, including user roles 206, user profiles 208 and profile templates 210. The computing device 202 may include modules containing instructions that when executed by a processor 230 perform certain actions. These modules may include a role identification module 212, a profile identification module 214, a validating module 216, an action module 218, a profile template module 220 as well as other services, processes, systems, engines, or functionality not discussed in detail herein. The role identification module 212 may be configured to identify one or more user roles 206 that may be stored in the data store 204 and provide the one or more user roles 206 to the validating module 216. A user role 206 may be used to determine a level of security within a flight management system 200 that may be granted to a user. In some cases, a user may be assigned multiple user roles 206 that allow the user to access different aspects of a flight management system 200. For example, in a flight management system 200 that contains user roles 206 for pilots, instructors, staff and maintenance, a user may be assigned one or more of these user roles 206. For instance, a user may be both a pilot and an instructor. Moreover, the user may also be employed by a flight entity as a staff member who manages a reception desk and also works as an aircraft maintenance employee for the flight entity. The role identification module 212 can identify multiple user roles 206 for a user in the case where the user has more than one user role 206 and provide the user roles 206 to the validating module 216.

The profile identification module 214 may be configured to identify at least one user profile 208 having user profile data for a user. A user profile 208 may be a collection of attributes that identify and describe a user. As an example, a user profile 208 may contain personal information about a user and information that relates to one or more user roles 206 associated with the user in the flight management system 200. For example, a user having a maintenance user role may have an associated maintenance user profile that may contain information about various aircraft maintenance certifications that the user may have completed.

A flight management system 200 may provide various user profile types that may be associated with user roles 206. For instance, a pilot user profile may be associated with a pilot user role and a maintenance user profile may be associated with a maintenance user role. Further, each user profile type may include user profile sub types. For instance, a pilot user profile may further include a renter user profile and a student user profile. The user profiles 208 for a user may be identified by the profile identification module 214 and a user profile 208 associated with an action that a user may be requesting may be provided to the validating module 216.

The validating module 216 may be configured to determine a user's authorization to perform a requested action within a flight management system 200 by validating one or more user roles 206 provided by the role identification module 212 and validating information from one or more user profiles 208 provided by the profile identification module 214. The validation module 216 may determine what user role 206 may be needed to perform the action that the user may be requesting and then determine whether the user has been assigned the user role 206 that may be needed.

Using a rules engine 222, the validating module 216 may then provide the rules engine 222 with the information from a user profile 208. The rules engine 222 may use the information to determine whether the user profile 208 contains the appropriate information that would allow the user to perform the requested action. As an example, a user wishing to rent and schedule a helicopter using a flight management system 200 may make the request to rent and schedule the helicopter by providing the user's credentials (e.g., login information). In order to schedule and rent a helicopter, a user may need to be assigned a pilot user role and may need a pilot profile that states that the user is licensed and certified to pilot the type of helicopter that the user is requesting. The validating module 216 may first determine that the user has been assigned a pilot user role and then may determine whether the user has a pilot profile containing the appropriate information that allows the user to operate the type of helicopter. After a user role 206 and a user profile 208 have been validated by the validating module 216, an action module 218, which may be configured to perform a certain action requested by a user, can then perform the action.

The computing device 202 may contain a profile template module 220 that may be configured to construct a user profile 208 using a profile template 210. The user profile 208 may be constructed by first determining a profile template 210 that may be associated with a user role 206. As described earlier, a user profile 208 may be related to a user role 206 (e.g., a pilot profile may be related to a pilot user role). Thus, the profile templates 210 may include a variety of profile template types that may be related to a specific user role 206. Based on a user role 206 assigned to a user, a profile template 210 related to a user role 206 may be selected. Upon selecting a profile template 210, one or more template fields of the profile template 210 may be populated with pre-determined data based on the profile template type selected. For example, a pilot user template may be pre-populated with data that may be common to all or most pilots within the flight entity.

Custom template fields may be made available to a user that the user may incorporate into the profile template 210. Information entered into a custom template field may be identified and included in a user profile 208 that may be created from an associated profile template 210. In one example, a graphical user interface may be provided to a user that displays a profile template 210 with associated template fields. The graphical user interface can provide a user the ability to add template fields to the profile template 210 and customize the template field to the user's purpose.

Input entered into the template fields of the profile template 210 can be validated using compliance criteria that may be associated with a profile template type. For instance, some profile templates types within a flight management system 200 may be associated with FAA (Federal Aviation Administration) rules that certain information be provided in a user profile 210. As a specific example, a pilot profile template may be coupled with a rule that a user provide a flight entity with a proof of citizenship. The proof of citizenship that the user provides may be made part of a pilot profile when the pilot profile is created from the pilot profile template. The proof of citizenship template field of the pilot profile template can be validated for compliance to the rule that proof of citizenship be provided. In a case where a validation for compliance fails, a user may be notified allowing the user to remedy the deficiency. Once all compliance issues may have been met, a user profile 210 may then be created from the profile template 210 using the template fields and associated input.

The client device 240 and/or the mobile device 256 included in the flight management system 200 may include any device that is capable of sending and receiving data over a network 236. The network may be a wired or a wireless network such as a local area network (LAN), wide area network (WAN), wireless local area network (WLAN), or wireless wide area network (WWAN). The WLAN may be implemented using a wireless standard such as Bluetooth or the Institute of Electronics and Electrical Engineers (IEEE) 802.11-2012, 802.11ac, 802.11ad standards, or other WLAN standards. The WWAN may be implemented using a wireless standard such as the IEEE 802.16-2009 or the third generation partnership project (3GPP) long term evolution (LTE) releases 8, 9, 10 or 11.

A client device 240 may comprise, for example, a processor-based system such as a computing device. Such a computing device may contain one or more processors 248, one or more memory modules 246 and a graphical user interface 242. A client device 240 may be a device such as, but not limited to, a desktop computer, mainframe computer system, workstation as well as other devices with like capability. A mobile device 256 may be a device such as laptop or notebook computer, tablet computer, handheld computer, smartphone or other devices with like capability. The client device 240 and the mobile device 256 may have one or more applications 252 installed that may provide access to a flight management system 200. Also, a client device 240 and a mobile device 256 may include a browser 250 that may enable the communication with the computing device 202 by way of a server side executed application that may be displayed within the browser 250. The client device 240 and the mobile device 256 may include a display 244, such as a liquid crystal display (LCD) screen, gas plasma-based flat panel display, LCD projector, cathode ray tube (CRT), or other types of display devices, etc.

The various processes and/or other functionality contained on the computing device 210 may be executed on one or more processors 230 that are in communication with one or more memory modules 232 according to various examples. The computing device 210 may comprise, for example, of a server or any other system providing computing capability. Alternatively, a number of computing devices 210 may be employed that are arranged, for example, in one or more server banks or computer banks or other arrangements. For purposes of convenience, the computing device 210 is referred to in the singular. However, it is understood that a plurality of computing devices 210 may be employed in the various arrangements as described above.

Various data may be stored in the data store 204 that is accessible to the computing device 202. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 204 may include non-transitory storage systems such as a SAN (Storage Area Network), cloud storage network, volatile or non-volatile RAM, optical media, or magnetic hard-drive type media. The data store 204 may be representative of a plurality of data stores 204 as can be appreciated.

The network 236 may include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 2 illustrates that certain processing modules may be discussed in connection with the present technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, cloud, grid or cluster computing system. An application program interface (API) may be provided for each module to enable a second module to send requests to and receive output from the first module. Such APIs may also allow third parties to interface with the module and make requests and receive output from the modules. While FIG. 2 illustrates an example of a flight management system 200 that may implement the techniques above, many other similar or different environments are possible. The example environments discussed and illustrated above are merely representative and not limiting.

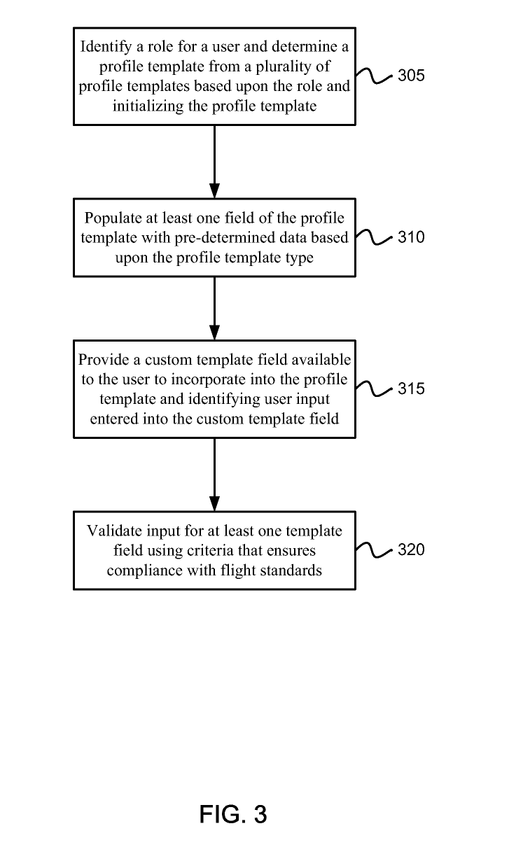

FIG. 3 is a flow diagram illustrating an example method for constructing a multi-role user profile for a user of a flight management system. Beginning in block 305, a role for a user may be identified and a profile template may be determined from a plurality of profile templates based upon the role. Once a role and a profile template have been identified, the profile template may be initialized. Examples of roles that may be assigned to a user may include, but are not limited to: a pilot user role, student user role, instructor user role, maintenance user role, staff member user role, dispatch user role, visitor user role and administrator user role. Each role may provide a user with specific rights that enable the user to view information associated with a role and perform specific actions associated with the role within a flight management system.

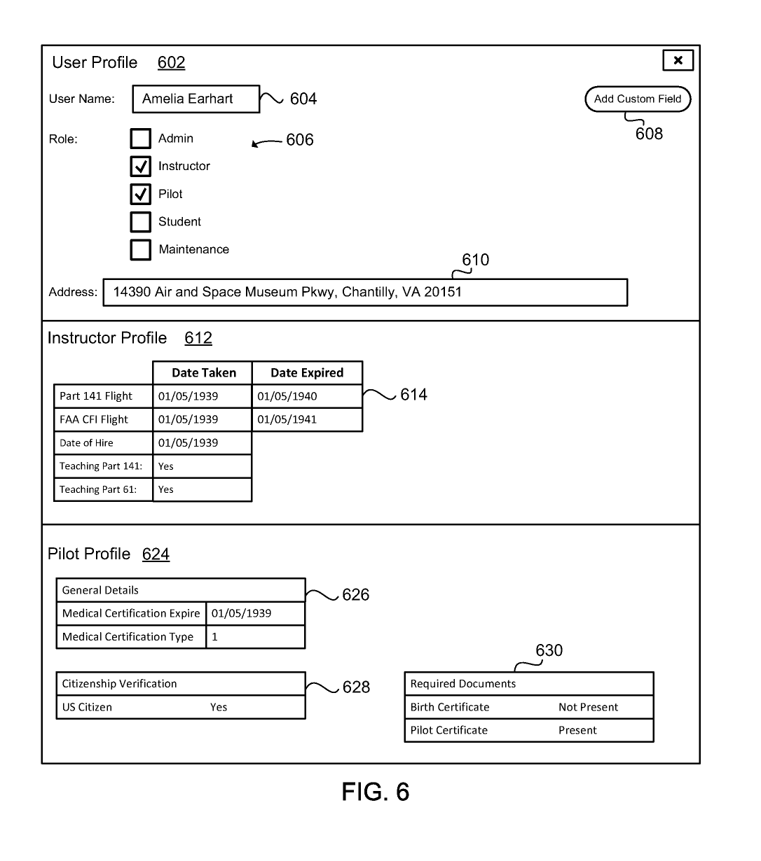

Profile templates may be related to roles such that a profile template may contain fields for information that may be relevant to a role. Referring to FIG. 6 is an example of a user profile 602 that includes a pilot profile 624 for a user that has been assigned a pilot user role 606. The fields of the pilot profile 624 may contain fields that may be relevant to the pilot user role 606. As a specific example, the pilot profile 624 may provide fields 626 that may be related to a pilot's medical certification that enables the pilot to operate an aircraft. Returning to FIG. 3, a profile template may be selected based at least in part on the role identified for the user. Thus, if a pilot user role is identified for a user, then a pilot profile template may be selected and initialized.

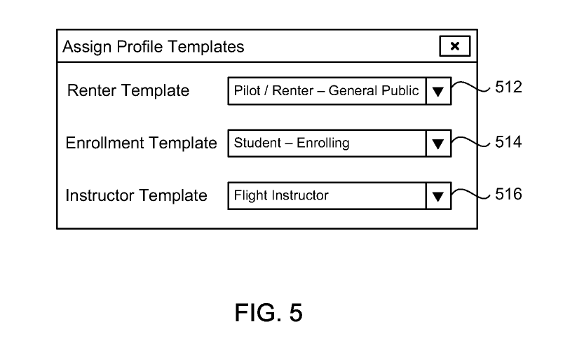

In a case where a user may have been assigned multiple roles, one or more profile templates may be identified that may be related to the roles. Referring to FIG. 5 is an example of a graphical user interface containing fields 512, 514 and 516 that provide available profile templates that may be related to a specific role. As a specific example, a user may be assigned a pilot user role, a student user role and an instructor user role. Because the user has been assigned multiple roles, one or more profile templates may be identified for each role. Thus, as is shown in FIG. 5, the user may create a pilot profile using a pilot/renter profile template 512, a student profile using a student enrollment profile template 514 and an instructor profile using a flight instructor profile template 518.

Returning again to FIG. 3, once a profile template that may be related to a user role has been identified, the profile template may be initialized and presented to a user so that the user may enter information into the profile template. As in block 310, one or more fields of a profile template may be populated with pre-determined data based upon the profile template type. For example, template fields for a pilot profile template may be populated with pre-determined data relating to a pilot, whereas template fields for an aircraft mechanic profile template may be populated with pre-determined data relating to a mechanic.

As in block 315, a custom template field may be provided to a user that may be available to incorporate into the profile template. For example, using a graphical user interface, a user may add fields to a profile template. The added custom fields may be labeled by the user and input entered into the custom fields may be identified and incorporated into a resulting user profile. In one example, a custom template may be associated with a rules engine where a user may define a rule for the custom template. When a user profile may be validated, information entered into the custom template field may be validated using the rule engine. As an illustration, a flight club using a flight system management system may wish to add a custom template field to a pilot profile that designates the pilot's status within the flight club. An administrator of the flight management system may create the custom template field and then define a rule for the custom template field that mandates that the field contain a value other than a null value. When a pilot profile is created for a member of the flight club, the custom template field may be validated to ensure that the custom template field does not contain a null value.

In another example, custom template fields may be incorporated into a profile template and the profile template may be saved to memory with an associated name and description so that the profile template with the incorporated custom template fields may be reused. Thus, when the profile template is used to create a profile for another user, the custom template fields may not need to be recreated. As an illustration, a flight school may train pilots under two different United States federal aviation regulations. The flight school may create a profile template with custom template fields for flight students training under Federal Aviation Regulations Part 61 and another profile template with custom template fields for flight students training under Federal Aviation Regulations Part 141. Flight students training under Federal Aviation Regulations Part 61 do not need to follow a syllabus, whereas flight students training under Federal Aviation Regulations Part 141 must be taught using an FAA approved syllabus. Thus, a profile template for flight students training under Federal Aviation Regulations Part 141 may include custom template fields that are associated with an FAA approved syllabus. The two profile templates, along with any custom template fields, can be saved and reused each time a new student pilot enrolls into a flight training program.

As in block 320, input for one or more template fields of a profile template may be validated using criteria that may ensure compliance with governmental flight standards and/or proprietary flight management system standards. For example, government regulations may provide that a person wishing to enroll in flight lessons must provide certain information (e.g., birth certificate). Included in a profile template may be template fields that captures information that governmental regulations may stipulate. When these template fields are validated, a process may verify that the information in one or more of the template fields is the information stipulated by the government regulation. Additionally, a flight entity may instruct that certain information be provided by a user and included in a user's profile. For example, a profile template may include template fields that capture billing information and a process may verify that the information entered into the template fields may be correct. In some cases, a user may verify information that may be entered into a template field (i.e., a manual validation).

Once input entered by a user into a profile template has been validated, a user profile may be constructed using the template fields and associated input. For example, information from the profile template may be saved to a data store and may be associated with a user. Thereafter, the information may be retrieved from the data store whenever the user profile may be requested.

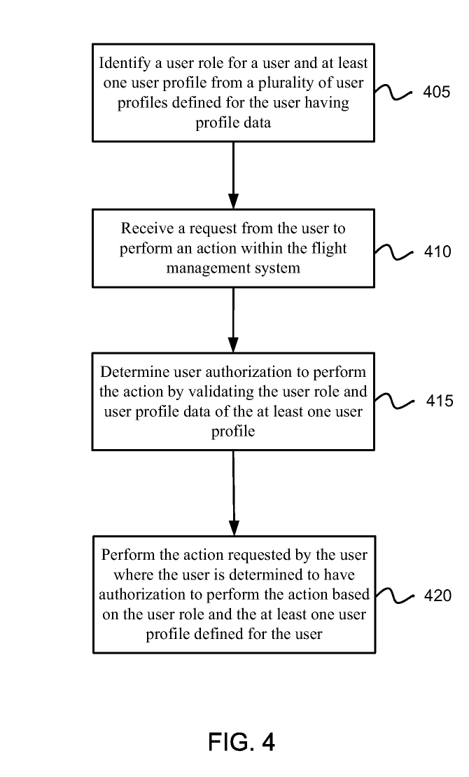

Moving now to FIG. 4, a flow diagram illustrating an example method for determining access to functionality of a flight management system is shown. A user may be provided with a user role and a user profile that allows the user to perform certain actions within the flight management system. As a specific example, a user having a student user role and a student enrollment profile may have the ability to schedule a flight lesson with a flight instructor using the flight management system. A process may examine the user role and the user profile to determine whether the user can schedule the flight lesson.

Beginning in block 405, a user role and at least one user profile may be identified for a user. In one example configuration, a user role and a user profile may be identified when a user logs into a flight management system. In another example configuration, the user role and the user profile may be identified when a user makes a request to perform an action within the flight management system.

As described earlier, a user may be assigned one or more user roles that provide a user certain rights within a flight management system. For instance, a user role may allow a user to perform certain actions within the flight management system. In one example, a user role may determine whether certain functionality of the flight management system may be displayed to the user. Flight management system functionality may be hidden from a user where the user does not have a user role that allows the user access to the functionality. Thus, as a specific example, a user having a pilot user role or an instructor user role may be able to schedule a flight training course or schedule a flight resource such as an airplane. Whereas a user with a maintenance user role may not have access to functionality that enables the user to schedule a flight training course or an airplane. In another example, a user having an administrative user profile may have access to all functionality and information within a flight management system, as well as the ability to override or bypass validation processes within the flight management system.

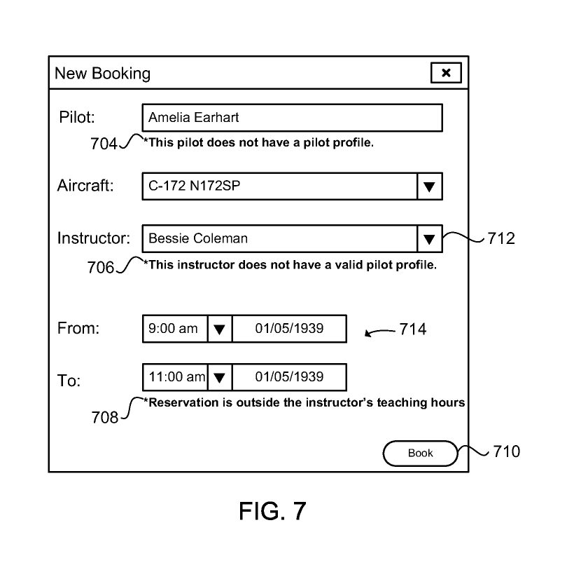

As in block 410, a request may be received from the user to perform an action within the flight management system. An action may be some function that may be performed within a flight management system, such as renting an aircraft, enrolling in a flight lesson, creating an invoice, performing administrative duties, etc. Upon receiving an action request, as in block 415, user authorization to perform the action may be determined by validating the user role and profile data of the at least one user profile. The user role may be used to determine whether the associated user has been granted access to the functionality of the flight management system connected with the action requested. If the user has a user role that allows the action, then profile data from a user's profile may be validated to ensure that the user profile contains any data that may be needed to allow the requested action. For example, referring to FIG. 7, a user with a pilot user role may make a request to book a flight lesson. When the user requests to book the flight lesson 710, data from the user's profile may be validated to ensure that the user has a valid pilot profile. In the event that the user does not have a valid pilot profile, the user may be presented with a notification 704 that the user has a deficient pilot profile. Without a valid pilot profile, the user may not be allowed to book the flight lesson 710.

In addition to validating a user profile for a user requesting that an action be performed, profiles of resources that may be connected with the action being requested may be validated prior to the action being performed. For example, referring again to FIG. 7, a user requesting an action to book a flight lesson 710 may specify an instructor 712 for the flight lesson. Upon requesting that the flight lesson be booked 710, the user profile for the instructor 712 may be validated to ensure that the instructor's pilot profile contains data that may be needed in order to conduct the flight lesson. In a case where the instructor's pilot profile may be deficient, a notification 706 may be displayed to the user indicating to the user that the instructor may not have a valid pilot profile and therefore cannot be booked for the flight lesson.

Also, certain aspects of a user profile may be examined to determine whether an action may be performed. For instance, a user profile may contain any type of information that may be relevant to a user's role within a flight management system and the information may play a role in whether a particular action may be performed. As a specific example, again referring to FIG. 7, when booking a flight lesson, a user may specify a flight instructor 712 for the flight lesson and specify a date and time 714 for the flight lesson. In one example, an instructor profile may include a schedule that states when an instructor may be available for a flight lesson. Upon requesting that the flight lesson be booked 710, the schedule contained in the instructor profile may be referenced to determine whether the instructor 712 may be available during the date and time 714 specified in the proposed booking. In a case where the instructor 712 may not be available, a user may be provided with a notification 708 that the instructor is not available for the specified data and time 714 preventing the booking of the flight lesson.

Returning to FIG. 4, after the user role and the user profile may have been validated, as in block 420, the action requested by the user may be performed where the user may be determined to have authorization to perform the action based on the user role and the at least one user profile defined for the user.

FIG. 6 illustrates an example user profile 602 that may be constructed for a user of a flight management system. A user profile 602 may include personal information, such as a user's name 604 and address 610, and may include information about one or more roles 606 that may have been assigned to the user. In one example, custom template fields may be added 608 to a user profile 602 that may customized to the needs of a flight entity.

The user profile 602 may be constructed using a number of profile templates (e.g., enrollment template, pilot template, instructor template, etc.). A profile template may be related to a role 606 that may be assigned to a user. As described earlier, a user may be assigned one or more roles 606 that provide a user access to functionality within the flight management system, where the functionality may be related to a role 606 assigned to the user. A user that has been assigned a role 606 may be presented with a profile template related to the role and the user may then build a user profile using the profile template.

One example of a profile template that may be used to construct a user profile may be an instructor profile template. A user that has been assigned an instructor role may build an instructor profile 612 using the instructor profile template. An instructor profile template may contain template fields that may be associated with an instructor role within a flight management system. For instance, a user may provide information about training that the instructor may have completed and courses the instructor may be certified to teach. A template field and information contained in the template field may then be used to build an instructor profile 612 that contains the information 614 that the user provided.

As illustrated in this example, a user may be assigned additional roles (i.e., a pilot role) and a profile template related to the role may be provided to the user. For example, a pilot profile 624 may be constructed from a pilot profile template. The pilot profile 624 may include information such as general details 626, citizenship verification 628 as well as required documentation 630 information. Information contained in a user profile may be verified when a user requests that certain actions be performed. For instance, when requesting performance of an action that may be related to a user's pilot profile 624, information 626, 628 and 630 included in the user's pilot profile 624 may be read and verified prior to the action being performed. In a case where a user profile may be deficient, such as when a required document 630 may be missing (e.g., birth certificate), then the deficiency may be identified and the user may be notified. As can be appreciated, the example user profile 602 and associated fields shown in FIG. 6 are merely representative of a number of user profiles and associated fields that could be included in a user profile and are not meant to limit the scope of the present technology.

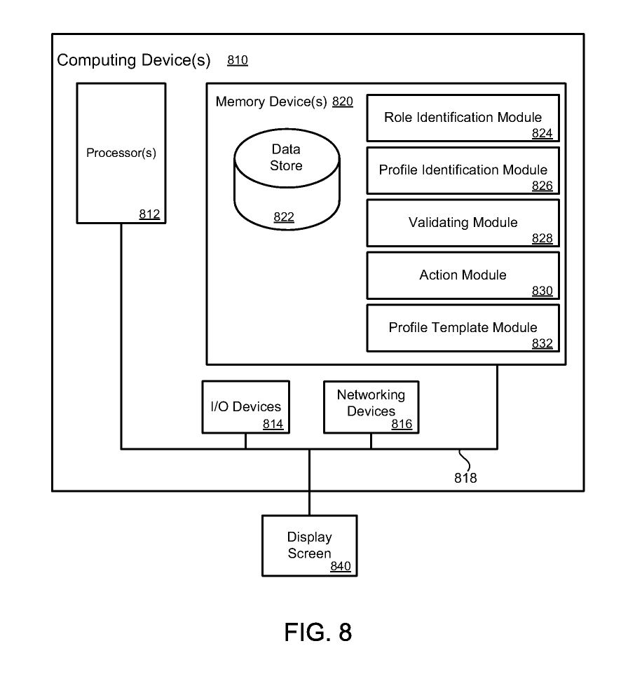

FIG. 8 illustrates a computing device 810 on which modules of this technology may execute. A computing device 810 is illustrated on which a high level example of the technology may be executed. The computing device 810 may include one or more processors 812 that are in communication with memory devices 820. The computing device 810 may include a local communication interface 818 for the components in the computing device. For example, the local communication interface may be a local data bus and/or any related address or control busses as may be desired.

The memory device 820 may contain modules that are executable by the processor(s) 812 and data for the modules. Located in the memory device 820 are services and modules executable by the processor. For example, a role identification module 824, a profile identification module 826, a validating module 828, an action module 830, profile template module 832 and other modules may be located in the memory device 820. The modules may execute the functions described earlier. A data store 822 may also be located in the memory device 820 for storing data related to the modules and other applications along with an operating system that is executable by the processor(s) 812.

Other applications may also be stored in the memory device 820 and may be executable by the processor(s) 812. Components or modules discussed in this description that may be implemented in the form of software using high programming level languages that are compiled, interpreted or executed using a hybrid of the methods.

The computing device may also have access to I/O (input/output) devices 814 that are usable by the computing devices. An example of an I/O device is a display screen 840 that is available to display output from the computing devices. Other known I/O device may be used with the computing device as desired. Networking devices 816 and similar communication devices may be included in the computing device. The networking devices 816 may be wired or wireless networking devices that connect to the internet, a LAN, WAN, WLAN, WWAN, or other computing network, as previously discussed.

The components or modules that are shown as being stored in the memory device 820 may be executed by the processor(s) 812. The term “executable” may mean a program file that is in a form that may be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be random access memory (RAM), read only memory (ROM), flash memory, a solid state drive, memory card, a hard drive, optical disk, floppy disk, magnetic tape, or any other memory components.

The processor 812 may represent multiple processors and the memory 820 may represent multiple memory units that operate in parallel to the processing circuits. This may provide parallel processing channels for the processes and data in the system. The local interface 818 may be used as a network to facilitate communication between any of the multiple processors and multiple memories. The local interface 818 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for determining access to functionality of a flight management system, comprising:
under control of one or more computer systems configured with executable instructions,
identifying a user role for a user and at least one user profile from a plurality of user profiles defined for the user having profile data;
receiving a request from the user to perform an action within the flight management system;
determining user authorization to perform the action by validating the user role and user profile data of the at least one user profile;
performing the action requested by the user where the user is determined to have authorization to perform the action based on the user role and the at least one user profile defined for the user.

2. A method as in claim 1, wherein identifying a user role for the user further comprises identifying a plurality of user roles for the user.

3. A method as in claim 1, wherein determining user authorization further comprises bypassing validation of the user profile data when a user role is defined with user rights that allow the user to bypass validation of the user profile data.

4. A method as in claim 1, wherein determining user authorization further comprises identifying user profile data deficiencies for the user profile and providing the user profile deficiencies to the user.

5. A non-transitory machine readable storage medium, including program code, when executed to cause a machine to perform the method of claim 1.

6. A computing node operable to provide a profile template used to build a multi-role user profile for a user of a flight management system, having computer circuitry configured to:
identify a role for the user and determine a profile template from a plurality of profile templates based upon the role and initializing the profile template;
populate at least one field of the profile template with pre-determined data based upon the profile template type;
provide a custom template field available to the user to incorporate into the profile template and identifying user input entered into the custom template field; and
validate input for at least one template field using criteria that ensures compliance with flight management system standards.

7. A method as in claim 6, wherein flight standard compliance includes governmental flight school standards and proprietary flight school standards.

8. The computer circuitry of claim 6, further comprising identifying user input for a template field and populating at least one related template field that is associated with the template field with pre-determined data, wherein the pre-determined data selected for the related template field is based at least on part of the user input.

9. The computer circuitry of claim 6, wherein the role for the user is a pilot role, a student role, an instructor role, a chief instructor role, an assistant instructor role, a dispatch administrator role, a back office administrator role, a super administrator role, a maintenance role, a maintenance manager role, a staff user role, a staff manager role, a curriculum manager role, an audit role, a report role, a visitor role or a tourist role.

10. The computer circuitry of claim 6, wherein the profile template type is for user enrollment, a flight instructor, an aircraft renter, a flight student, a flight course, staff, maintenance, external template, rules, security or an aircraft.

11. The computer circuitry of claim 6, further comprising saving the profile template with an associated name and description, wherein the profile template is available to reuse.

12. The computer circuitry of claim 6, wherein validation of the template field input is performed by a user.

13. The computer circuitry of claim 6, further comprising constructing a user profile using the profile template.

14. The computer circuitry of claim 13, further comprising identifying a user role when the user provides credentials to access the flight management system;
identifying at least one user profile defined for the user;
determining based on the at least one user profile identified for the user whether the user has access to functionality available as part of the flight management system when the user attempts to access the functionality; and
allowing access to the functionality of the flight management system where the at least one user profile is determined to allow the user access.

15. The computer circuitry of claim 14, wherein determining whether the user has access to functionality is determined by validating data in the user profile against a set of authorization criteria.

16. The computer circuitry of claim 14, further comprising displaying functionality of the flight management system based upon the user's role and the user's at least one user profile, wherein authorized functionality is displayed to the user and unauthorized functionality is hidden from the user.

17. The computer circuitry of claim 14, wherein the functionality of the flight management system includes flight course enrollment and flight resource scheduling.

18. A system for determining flight management system access for a user based on a user role and a user profile, comprising:
a processor;
a user profile data store that stores a plurality of user profiles and associated user profile data.
a memory device including instructions that when executed by the processor, cause the processor to execute:
a role identification module that identifies at least one user role for the user;
a profile identification module that identifies at least one user profile having user profile data for the user;
a validating module that determines user authorization to perform an action requested by the user by validating the at least one user role and validating the user profile data of the at least one user profile; and
an action module that performs the action requested by the user where the user is authorized to perform the action based on the user role and the at least one user profile.

19. A system as in claim 18, further comprising a profile template module configured to construct a user profile using a profile template and associated input, wherein a profile template is constructed by:
determining a profile template type based upon a user role;
populating at least one field of the profile template with pre-determined data based upon the profile template type;
providing custom template fields available to the user to incorporate into the profile template and identifying user input entered into the custom template fields; and
validating input for at least one template field using compliance criteria based on the role for the user.

20. A system as in claim 18, further comprising a profile template data store that stores a plurality of profile templates that have been created and saved to the profile template data store and are available for retrieval from the profile template data store so that a profile template can be reused.
